(19) United States
(12) Patent Application Publication
(10) Pub. No.: US 2011/0142226 A1
(43) Pub. Date: Jun. 16, 2011

(54) METHOD OF GENERATING PSEUDO-RANDOM BIT STRINGS

(75) Inventors: David Lefranc, Cormeilles-En-Parisis (FR); Philippe Painchault, Asnieres-sur-Seine (FR)

(73) Assignee: THALES, Neuilly Sur Seine (FR)

(21) Appl. No.: 12/599,716

(22) PCT Filed: May 12, 2008
(86) PCT No.: PCT/EP2008/055792

§ 371 Date: Feb. 22, 2011

(30) Foreign Application Priority Data
May 11, 2007 (FR) 0703384

(51) Int. Cl. H04L 9/28

(52) U.S. Cl. 380/28

(57) ABSTRACT

Method for generating pseudo-random bit strings in a system in which the data interchanges between a first user and a second user are protected, characterized in that it comprises at least the following steps: using an application fₖ of output size n bits, determining a value x and, from this value x and by applying the application fₖ, generating t values vᵢ, from the t values vᵢ and, from u*t coefficients, determining u blocks Sᵢ containing pseudo-random characters. Applicable to the coding or authentication domain.

The subject of the invention relates to a method for generating pseudo-random characters or pseudo-random bit strings. It is, for example, used for the protection of data confidentiality.

The invention applies, for example, to the field of cryptography. In particular, it relates to the cryptographic methods for protecting the confidentiality of data interchanges between two applications. It is used in all data coding/decoding systems that require data interchanges to be protected. It can be used in the field of user or data authentication.

At the present time, the property of confidentiality can be obtained according to different methods, all based on one and the same principle. Taking a communication channel that is assumed to be unsecured between two applications denoted A and B, and assuming that A wants to send confidential data to an application B via this communication channel, to do this, the application A must “mask” the data, then transmit them to the application B. In order for the application to be able to recover the original data from the masked data, the application A needs to have used a “masking method” that is easily reversible for B, and only for B, and possibly for A, in order that no other person can acquire the data. To obtain such a masking technique, cryptography distinguishes between two different approaches: public key cryptography, also called asymmetrical cryptography, and secret key cryptography, also called symmetrical cryptography. In each of these methods, the data are represented in the form of a character string, the characters generally used being the characters 0 and 1 which are then called bits.

Public key cryptography relies on the fact that the application B has a pair of keys denoted (P, S) such that:
P is a value known to the whole world and is called public key,
S is a value known only to the application B and is called private key.

The values of P and S are linked by a mathematical relationship such that it is difficult to find S simply by knowing P. Thus, only the application B is able to know the value S.

In public key cryptography, the application A uses the public key P of the application B to code the data. In this context, it is necessary to have the private key to be able to decode the data. Thus, only the application B is able to know the value S.

Secret key cryptography relies for its part on the fact that the application A and the application B have one and the same value S known only to them. The value S is called secret key. Thus, the application A uses the value S to code the data so that S must be known in order to decode the coded data. The application B is then the only one, with the application A, to be able to decrypt, which clearly guarantees the confidentiality of the data.

The protection of the confidentiality in the context of secret key cryptography (symmetrical cryptography) is generally called a symmetrical encryption method. There are two categories of encryption methods. The first is called streaming encryption and the second is called block encryption. In streaming encryption, the different characters representing the data are coded successively one by one. In block encryption, the character string representing the datum is subdivided into the form of several consecutive blocks of characters and these blocks, all of the same size, are then coded in succession. Each time a block is encoded, several characters are therefore coded simultaneously.

There are numerous block encryption methods. All these solutions rely on the use of a cryptographic primitive. A cryptographic primitive f is an application that takes as input a string denoted m of n characters and a string denoted K of k characters. At the output, the primitive f supplies a string of N characters denoted C satisfying C=f(m, K), with N not necessarily equal to n.

Each choice of an input K defines an application f_{K} such that f_{K}(m)=f(m, K). The input K is called secret key.

The present invention relates notably to the case where the cryptographic primitive f defines, for each possible value K, a bijective function f_{K} (in particular n=N). The application f_{K} obtained in this way is also called permutation (term preferentially used in the present description). Thus, each secret key K defines a permutation f_{K}. In practice, the primitive f can be AES or DES.

To code a block m containing n characters, it is sufficient to use the function f_{K} once. For example, it can be envisaged that the coding, denoted C, of the block m is computed by C=f_{K}(m). In practice, the confidential datum will not contain a single block, but, on the contrary, will be written like the series of b blocks denoted mᵢ, . . . , m_{b}. It becomes important to know how to code these b blocks. By drawing from the computation C=f_{K}(m), it is possible to envisage having the different blocks mᵢ, 1≦i≦b, coded in blocks denoted Cᵢ, 1≦i≦b, satisfying Cᵢ=f_{K}(mᵢ).

Specifying how to code a number of blocks of one and the same message consists in defining a procedure. The one defined above and consisting in coding each block independently of one another and passing them as input for the permutation f_{K} is the ECB mode. The security of this mode is not very high. The problem with this mode is that a block mᵢ, whatever its position in the message, will always be coded by the same value Cᵢ. This in practice poses a real problem.

There are a large number of procedures, some being standardized by the NIST [NIS01]. Different criteria exist for judging the quality of these modes. The main two are the level of security of this mode and the computational cost generated by this mode.

The security of a procedure represents the fact that it is difficult to decide whether a given character string is the result of the coding of a datum via this procedure, or if, on the contrary, this character string is a character string taken at random. If such a distinction is difficult, then it is reasonable to think that this procedure is relatively safe. However, this security is guaranteed only when the number of blocks coded by the selected procedure remains less than a constant (dependent on the mode). This constant is generally expressed in the form 2^{na} with n being the size of the block and a value between ½ and 1. The value a will generally be called security threshold. The computational cost represents the number of calls to the cryptographic primitive to code a message of b blocks. The ideal computational cost is b calls on the permutation f_{K} (such is the case with the ECB mode).

The security of the mode is partly associated with the value a. Obviously, the greater the value a, the greater the value 2^{na} and the longer the mode remains safe. The table below reviews the security of the modes standardized by the NIST. It also specifies whether the associated security model is high (preferable) or on the contrary low (rather detrimental). The formal security arguments can be found in [BDJR97] and [SULY01].

| Procedure | Security-related constant | Security reference |
|---|---|---|
| ECB [NIST01] | ½ (low-security model) | [BDJR97] |
| CFB [NIST01] | ½ (high-security model) | [SLLLY01] |
| OFB [NIST01] | ½ (high-security model) | [SLLLY01] |
| CBC [NIST01] | ½ (high-security model) | [BDJR97] |
| CTR [NIST01] | ½ (high-security model) | [BDJR97] |

The existing (and standardized) solutions have security that does not exceed the threshold ½.

The prior art discloses three proposals with which to go beyond the security threshold ½ if necessary. The first two [KNU00] and [ABAG01] have been supplied with proof of security that is virtually nonexistent for the first and in a low model for the second so that it is not possible to know if these modes effectively have a constant greater than ½. The third solution [IWA06] manages to reach the security threshold ⅔ with a complete proof of security and in a high-security model. The latter proposal also has a computational cost close to the ideal computational cost (almost similar to the cost of the ECB mode).

The present invention relates to a method of generating pseudo-random character strings from an application, for example a permutation f_{K}, of an initial value x and of coefficients αᵢ. The present invention can in particular be used for block encryption.

The subject of the invention relates to a method for generating bit strings in a system in which the data interchanges between a first user and second user are protected, characterized in that it comprises at least the following steps:
using an application f_{K} of output size n bits,
determining a value x and from this value x and by applying the application f_{K} a number of times, in order to generate t values vᵢ,
from the t values vᵢ and the u*t coefficients, determining u blocks Sᵢ containing pseudo-random characters.

According to one embodiment, the subject of the invention relates to a method for generating pseudo-random bit strings, within a system comprising a module for coding data, such that a message of b=f*u*n+q bits, in which f and u are greater than or equal to 0, and q is between 0 and u*n, can be placed in the form of f groups of u blocks of n bits and an (f+1)th group of q bits, characterized in that: the coding of a group concerned of u blocks comprises at least the following steps:
for the group concerned, choosing an initial value x,
from the t values vᵢ generated and from u*t coefficients, determining u blocks Sᵢ containing pseudo-random characters in order to code the u blocks of the group concerned,
combining the u blocks of the group concerned with the u blocks Sᵢ in order to obtain the coded group,
reiterating these three steps for the f groups, for the (f+1)th group of q bits,
choosing an initial value of x,
from the t values vᵢ generated and from u*t coefficients, determining a number of blocks Sᵢ equal to at least the top integer part of q/n,
combining q bits extracted from the Sᵢ blocks determined with the q bits of the (f+1)th group.

The invention is, for example, used in authentication applications. One of the benefits of the present invention is that it makes it possible to construct new pseudo-random functions that have an output of size greater than n. Generally, the existing constructions have an output only of n bits while using permutation f_{K} several times. These constructions therefore have a very low efficiency (at best, they manipulate the block algorithm twice to output n bits, the efficiency then being ½, which in practice is not acceptable. The present invention uses the permutation f_{K} several times, but to generate u blocks of n bits. Furthermore, the efficiency obtained is almost equal to 1.

Other features and benefits will become apparent from reading the following detailed description given by way of nonlimiting example and in light of the figures that represent:

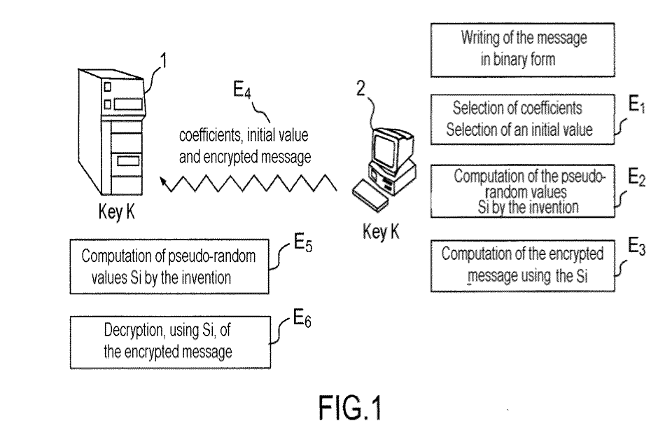

FIG. 1, an example of secure data interchanges between a banking server and a user,

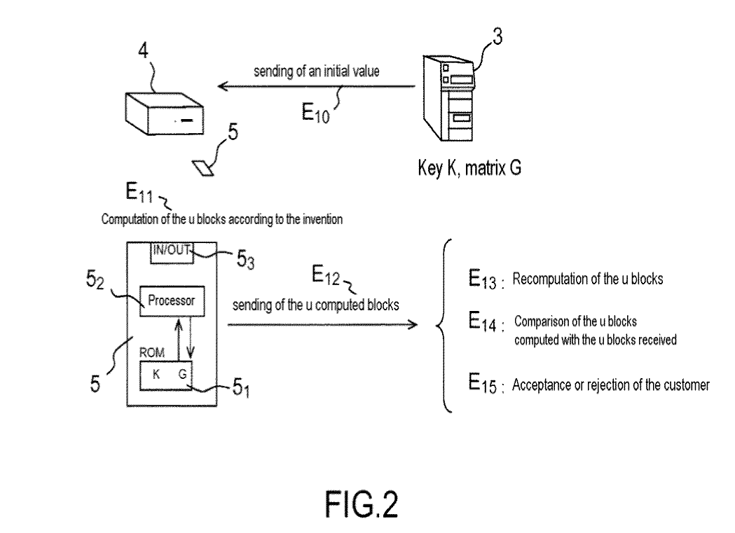

FIG. 2, an example of use of the method according to the invention in an authentication system.

One aim of the invention is to create new pseudo-random functions by using, notably, permutations, the output of which is a block of n bits; the output of the new function being of a size equal to a multiple of n bits, denoted u*n bits, u being an integer number.

The principle of the invention consists, notably, in considering t calls to the block algorithm generating as output a block of n bits in order to obtain t strings of n bits which will then be organized appropriately according to coefficients supplied as parameters to obtain the u≦t blocks of n bits at the output of the function.

In order to give a better understanding of the object of the present invention, the example given relates to the implementation of the method for a case where the coefficients used to organize the t strings of n bits are the coefficients of a matrix generating a linear code. The linear codes have an associated distance denoted d. This distance is materialized in the coefficients of the associated generating matrix. Thus, these coefficients make is possible to organize the t strings so that the u≦t blocks of n bits from the output of the function are then sufficiently different (“distant”) from one another. Thus, even by trying combinations of these u output blocks, it remains difficult to damage the pseudo-random nature of the output (of u blocks of n bits) of the new function. Based on strong logic, the greater the distance of the code, the more difficult this damage becomes and the more strongly pseudo-random the function created in this way becomes. The level of security obtained by implementing the method is equal to d/d+1.

As has already been stated, such functions can also be used to define new procedures, such that their security is identical to the security of the underlying function used. Thus, by using the pseudo-random functions parameterized by linear code matrices obtained by the present invention, it is possible to obtain procedures with a level of security equal to d/d+1, in which d is the distance of the linear code used. In particular, by using linear codes of a distance greater than or equal to 3, it is then possible to obtain procedures that have a very high security, not described in the prior art.

According to an exemplary implementation, the method according to the invention relates to a method of generating pseudo-random character strings from a permutation f_{K}, of an initial value x and of coefficients αᵢ. The present invention can in particular be used to code a message subdivided into blocks.

In such a context, there are two possible considerations:
if the aim is to code u blocks of a message, it is then sufficient to have (in addition to the initial value, and the permutation) u*t coefficients αᵢ for any value t≧1.
If the u*t datum is available, t≧1 coefficients αᵢ (in addition to the initial value and the permutation), it is then possible to code u blocks.

Since the value of t is variable, the product of the coefficients u*t is variable and can vary according to the value of t.

The u*t coefficients are divided up into u sequences of t values. For more clarity, this distribution can be represented in the form of a matrix containing u rows and t columns as described hereinbelow. The matrix representation is used by way of illustration, in order to improve the understanding of the example given to illustrate the method, but is in no way essential to the satisfactory operation of the invention.

$$\begin{matrix}{α}_{1 , 1} & {α}_{1 , 2} & {α}_{1 , 3} & ⋯ & {α}_{1 , t} \\ {α}_{2 , 1} & {α}_{2 , 2} & {α}_{2 , 3} & ⋯ & {α}_{2 , t} \\ & ⋮ & & & \\ {α}_{u - 1 , 1} & {α}_{u - 1 , 2} & {α}_{u - 1 , 3} & ⋯ & {α}_{u - 1 , t} \\ {α}_{u , 1} & {α}_{u , 2} & {α}_{u , 3} & ⋯ & {α}_{u , t}\end{matrix}$$

According to the invention, the initial data x can be a value stored in the application, or a value obtained from a random or pseudo-random or deterministic process.

From this value x, it is possible to generate t values, represented by way of example in the present description in the form of a series v containing t values denoted vᵢ, 1≦i≦t. An example for v is: v=(v₁=f_{K}(x+1), v₂=f_{K}(x+2), v₃=f_{K}(x+3), . . . , f_{K}(x+t−1), vₜ=fₓ(x+t))

According to the invention, the application will choose, depending on its resources, to compute all or part of the t values denoted vᵢ, 1≦i≦t, and store them; or, on the contrary to compute the value vᵢ when this value is necessary.

The method according to the invention more generally accepts the use of t values obtained by a computation of the form gᵢ(f_{K},x), 1≦i≦t, in which the applications gᵢ are any applications (LFSR, affine transformation, linear transformation, divider register, modular addition, etc.). Thus, the preceding example corresponds to gᵢ(f_{K},x)=fₓ(x+i).

Other examples are chosen from the following non-exhaustive list:
gᵢ(f_{K},x)=f_{K}(x+i−1),
gᵢ(f_{K},x)=f_{K}(Lⁱ(x)) in which Lⁱ corresponds to the ith iteration of an LFSR or of a divider register,
gᵢ(f_{K},x)=f_{K}(aᵢx+bᵢ) in which aᵢ and bᵢ are coefficients of an affine transformation,
gᵢ(f_{K},x)=f_{K}(aᵢx+bᵢ mod 2ⁿ) in which aᵢ and bᵢ are coefficients of an affine transformation,
gᵢ(f_{K},x)=f_{K}(x+i)⊕dᵢ, in which ⊕ represents the bit-by-bit xor operation and dᵢ is a bit string,
gᵢ(f_{K},x)=f_{K}(x+i−1)⊕dᵢ, in which ⊕ represents the bit-by-bit xor operation and dᵢ is a bit string,
gᵢ(f_{K},x)=f_{K}(Lⁱ(x))⊕dᵢ, in which Lⁱ corresponds to the ith iteration of an LFSR or of a divider register, ⊕ represents the bit-by-bit xor operation and dᵢ is a bit string.

From the t values denoted vᵢ, 1≦i≦t, and from the u*t coefficients

| | | | | |
|---|---|---|---|---|
| α_{1, 1} | α_{1, 2} | α_{1, 3} | . . . | α_{1, t} |
| α_{2, 1} | α_{2, 2} | α_{2, 3} | . . . | α_{2, t} |
| α_{u-1, 1} | α_{u-1, 2} | α_{u-1, 3} | . . . | α_{u-1, t} |
| α_{u, 1} | α_{u, 2} | α_{u, 3} | . . . | α_{u, t} |

the method determines u blocks Sᵢ containing pseudo-random characters. The coding of u blocks denoted m₁, m₂, . . . , mᵤ into u coded blocks denoted C₁, C₂, . . . , Cᵤ will then be easily obtained from the u blocks Sᵢ. More specifically, for any i, 1≦i≦u, coding the different blocks mᵢ amounts to computing

Sᵢ=(α_{i,1} [symbol] v₁)⊕(α_{i,2} [symbol] v₂)⊕(α_{i,3} [symbol] v₃)⊕ . . . ⊕(α_{i,t} [symbol] vₜ)

Cᵢ=mᵢ⊕Sᵢ

in which [symbol] can represent:
Multiplication if it is defined. In particular,
   in the case a_{i,j}=1, a_{i,j} [symbol] vⱼ=vⱼ
   in the case a_{i,j}=0, a_{i,j} [symbol] vⱼ=0 (string of n bits all equal to 0). This is virtually the same as ignoring the term a_{i,j} [symbol] vⱼ
The selection of a proportion of bits. In particular, if 0≦α_{i,j}≦1, a_{i,j} [symbol] vⱼ represents the selection of a_{i,j}% of the n bits, according to a selection criterion known to the application.

And where ⊕ can represent:
the xor operation equal to the bit-by-bit “exclusive or”,
modular addition modulo 2ⁿ

The definition of the operands can vary within the computation of a block Sᵢ.

According to the invention, to code f*u blocks, it is sufficient to iterate the process described previously f times. Each iteration requires the following parameters:
the datum of an initial value x,
the datum of u*t coefficients,
the datum of the permutation f_{K} or of a chosen application.

According to the invention, if the application sees a benefit therein, it can code b blocks of a message, b being any number, considering b=u₁+u₂+ . . . +uₛ and code the u₁ blocks according to the method described in the present description, then the u₂ blocks with a new iteration of the method and so on, the different values u₁, u₂, . . . , uₛ possibly differing from one another, or some being equal, or even all being equal. On each iteration of the method of generating pseudo-random strings, the application can choose to retain all or part of the parameters from preceding iterations or on the other hand to use all different parameters.

### First Exemplary Implementation of the Invention

Assume the datum of an initial value x, a permutation f_{K} and the series of coefficients presented in the form of the matrix u*u (t=u).

$$\begin{matrix}1 & 0 & 0 & ⋯ & 0 & 0 & 0 \\ 0 & 1 & 0 & ⋯ & 0 & 0 & 0 \\ 0 & 0 & 1 & ⋯ & 0 & 0 & 0 \\ ⋯ & ⋯ & & & & & \\ 0 & 0 & 0 & ⋯ & 1 & 0 & 0 \\ 0 & 0 & 0 & ⋯ & 0 & 1 & 0 \\ 0 & 0 & 0 & ⋯ & 0 & 0 & 1\end{matrix}$$

Considering the datum of t values v obtained by vᵢ=f_{K}(x+i−1), for any i, 1≦i≦t=u, the operand ⊕ will be at any moment of the iteration the bit-by-bit exclusive or and the operand [symbol] will be the multiplication by 0 or 1 (the values of the coefficients) as defined previously.

Take a message of b bits, b being equal to f*u*n+q bits with f and u greater than or equal to 0, and q greater than or equal to 0 and strictly less than u*n, that has to be coded. The series of coefficients and the permutation f_{K} will, for example, be constant on each iteration, and the initial value will be x for the first iteration, then x+t for the second, then x+2t for the third and more generally x+(i−1)*t for the ith iteration. The u first blocks of n bits, those of the first group, will be coded using the first iteration (with x as initial value) of the present invention. For any i, 1≦i≦u, the coding of the block i denoted mᵢ is then obtained by application of the formula:

Sᵢ=(α_{i,1} [symbol] vᵢ)⊕(α_{i,2} [symbol] v₂)⊕(α_{i,3} [symbol] v₃)⊕ . . . ⊕(α_{i,t} [symbol] vₜ)

Cᵢ=mᵢ⊕Sᵢ

Now, all the coefficients of the row i of the matrix are zero, except the ith (identity matrix). Consequently, Sᵢ is reduced to

Sᵢ=α_{i,i} [symbol] vᵢ=vᵢ=f_{K}(x+i−1)

so that

Cᵢ=mᵢ⊕Sᵢ=mᵢ⊕f_{K}(x+i−1).

Upon the second iteration of the invention, for the coding of the second group of u blocks of n bits, the u subsequent blocks mᵤ₊ᵢ, 1≦i≦u, will be coded by computing

Sᵢ=α_{i,i} [symbol] vᵢ=vᵢ=f_{K}(x+u+i−1)

so that

Cᵤ₊ᵢ=mᵤ₊ᵢ⊕Sᵢ=mᵢ⊕f_{K}(x+u+i−1).

The two iterations can be expressed in the following common form.

For any i, 1≦i≦2u,

Sᵢ=f_{K}(x+i−1)

Cᵢ=mᵢ⊕Sᵢ

Ultimately, after f different iterations, the process of coding the u*f first blocks of the message is summarized in the form, for 1≦i≦u*f,

Sᵢ=f_{K}(x+i−1) coefficient to be used to code the block of index i

Cᵢ=mᵢ⊕Sᵢ value of the coded block of index i.

The last q bits, denoted in the form of a single block m′_{u*f+1} will be coded by generating sufficient blocks Sᵢ to be able to extract therefrom q bits, in order to form the block S′_{u*f+1}. The (f+1)th group is coded in a group C′_{u*f+1}=m′_{u*f+1}⊕S′_{u*f+1}.

### Second Exemplary Application

Assuming the data of an initial value x, a permutation f_{K} and the series of coefficients presented in the form of the matrix u*(u+1) (t=u+1).

$$\begin{matrix}1 & 1 & 0 & 0 & ⋯ & 0 & 0 & 0 \\ 1 & 0 & 1 & 0 & ⋯ & 0 & 0 & 0 \\ 1 & 0 & 0 & 1 & ⋯ & 0 & 0 & 0 \\ ⋯ & ⋯ & ⋯ & & & & & \\ 1 & 0 & 0 & 0 & ⋯ & 1 & 0 & 0 \\ 1 & 0 & 0 & 0 & ⋯ & 0 & 1 & 0 \\ 1 & 0 & 0 & 0 & ⋯ & 0 & 0 & 1\end{matrix}$$

Considering the datum of values vᵢ obtained by vᵢ=f_{K}(x+i−1), for any i, 1≦i≦t=u+1, the operand ⊕ will at any moment of the iteration be the bit-by-bit exclusive or and the operand [symbol] will be the multiplication by 0 or 1 (the values of the coefficients) as defined previously.

Take a message b=f*u*n+q bits, with f and u greater than or equal to 0, and q greater than or equal to 0 and strictly less than u*n, that has to be coded. The series of coefficients and the permutation f_{K} will be constant on each iteration, and the initial value will be x for the first iteration, then x+u+1 for the second, then x+2(u+1) for the third and, more generally, x+(i−1)*(u+1) for the ith iteration. The u first blocks will be coded using the first iteration (with x as initial value) of the present invention. For any i, 1≦i≦u, the coding of the block i denoted mᵢ is then obtained by applying the formula:

Sᵢ=(α_{i,1} [symbol] v₁)⊕(α_{i,2} [symbol] v₂)⊕(α_{i,3} [symbol] v₃)⊕ . . . ⊕(α_{i,t} [symbol] vₜ)

Cᵢ=mᵢ⊕Sᵢ

Now, all the coefficients of the row i are zero, except the 1st and the (i+1)th. Consequently, this formula is reduced to:

Sᵢ=(α_{i,1} [symbol] v₁)⊕(α_{i,i+1} [symbol] vᵢ₊₁)=v₁⊕vᵢ₊₁=f_{K}(x)⊕f_{K}(x+i−1)

so that

Cᵢ=mᵢ⊕f_{K}(x)⊕f_{K}(x+i−1)

On the second iteration of the invention, the u blocks mᵤ₊ᵢ for any i, 1≦i≦u, are coded by

Cᵤ₊ᵢ=mᵤ₊ᵢ⊕f_{K}(x+u−1)βf_{K}(x+u+1i−1)

and so on for the f first groups.

The last q bits, denoted in the form of a single block m′_{u*f+1} will be coded by generating sufficient blocks Sᵢ to be able to extract q bits therefrom, in order to form the block S′_{u*f+1}. The (f+1)th group is coded in a group C′_{u*f+1}=m′_{u*f+1}⊕S′_{u*f+1}.

### Obtaining New Procedures

In the preceding two exemplary applications of the invention used to illustrate the fact that the invention makes certain solutions exist as particular cases, the coefficients supplied in matrix form do not correspond to any values.

Regarding the counter mode, first example, the coefficient matrix supplied corresponds to the identity matrix, which can be considered as the matrix generating the linear identity code with which is associated a distance d=1.

In the second example, the matrix only having is on the first column corresponds to the matrix generating the linear parity code with which is associated the distance d=2.

Any correcting code has an associated dimension that corresponds to the original size of the words (according to the notations of the example u), a size that corresponds to the size of the words of the code (according to the notations of the example t) and a distance denoted d.

The present invention is of particular interest when the coefficients supplied correspond to the coefficients of a matrix generating a linear code of dimension u, of size t and of distance d. Such a matrix will have u rows and t columns.

Thus, the use of a generating matrix of size u*t as coefficient datum, an initial value x and a permutation f_{K} makes it possible, in one iteration, to code u blocks. Each iteration retains the same coefficients and the same permutation. Only the initial datum changes. Thus, on the ith iteration 2≦i, the initial datum has the value x+(i−1)*t.

By using the present invention in this way, it is then possible to prove the security of the procedure obtained in this way in a high-security model, and in particular, the distance d of the code is directly involved in the security analysis. Thus, it is possible to show that this procedure, consisting of the iteration of the method described previously, remains safe as long as the number of encrypted blocks remains less than 2^{nd/d+1}. Thus, by considering the matrix generating a linear code of distance 3, the security of the procedure described hereinabove is then guaranteed as long as the number of coded blocks remains less than 2^{3n/4}, a number that no other coding solution known from the prior art can hope to achieve.

For a linear code of distance 4, the security can be guaranteed in that the number of coded blocks is less than 2^{4n/5}, which is greater than 2^{3n/4}.

To sum up, and as a general rule, it is possible to use the present invention to generate pseudo-random bit strings, not necessarily dedicated to the problem of the coding of a message.

Example of Implementation of the Method According to the Invention within a System Enabling a User to Perform Transactions with a Banking Server.

Let us consider a connection between a bank server 1 and a client 2. The aim of these two entities is to conduct a dialogue together confidentially (transfer request, for example . . . ).

Let us assume that the server and the client both have one and the same 128-bit secret key K. The present invention makes it possible to provide this confidential communication.

In practice, consider that the customer wants to transmit to the bank a transfer order and let us assume that this order is represented by an electronic message M of size 8*128=1024 bits. Such a message can therefore be written in the form:

M=m₁ m₂ m₃ m₄ m₅ m₆ m₇ m₈

in which each mᵢ represents a block of 128 bits.

To transmit their order confidentially, the client will use the method according to the invention described hereinabove. For this, the server and the client then agree publically (i.e. in a non-secret manner):
on a block coding algorithm using 128-bit keys, called AES. AES(K, t) will be used to denote the coding of the 128-bit word t by using the secret key K.
on a series of binary values that can be represented in the form of a matrix G having 4 rows and 5 columns defined by

$$G = \begin{matrix}1 & 0 & 0 & 0 & 1 \\ 0 & 1 & 0 & 0 & 1 \\ 0 & 0 & 1 & 0 & 1 \\ 0 & 0 & 0 & 1 & 1\end{matrix}$$

Hereinafter, the operand ⊕ represents the bit-by-bit “exclusive or” operation. This operand satisfies:

A⊕A=0; A⊕B=B⊕A; (A⊕B)⊕B=A⊕(B⊕B)=A⊕0=A

The client 2 then chooses (step E₁) a first initial value x of size 128 bits and applies for a first time the present invention by using G to compute (step E₂) 4 (the number of rows of G) blocks Sᵢ of 128 bits defined by

S₁=AES(K, x)⊕AES(K, x+4)

S₂=AES(K, x+1)⊕AES(K, x+4)

S₃=AES(K, x+2)⊕AES(K, x+4)

S₄=AES(K, x+3)⊕AES(K, x+4)

From these four blocks Sᵢ, the client can code (step E₃) the first 4 blocks of the message M in 4 coded blocks cᵢ defined by

c₁=m₁⊕S₁; c₂=m₂⊕S₂; c₃=m₃⊕S₃; c₄=m₄⊕S₄

Then, the client can consider a second initial value x′. The client can once again apply the present invention with the initial value x′ and the matrix G representing the series of coefficients. The client then obtains 4 new blocks Sᵢ of 128 bits defined by

S₅=AES(K, x′)⊕AES(K, x′+4)

S₆=AES(K, x′+1)⊕AES(K, x′+4)

S₇=AES(K, x′+2)⊕AES(K, x′+4)

S₈=AES(K, x′+3)⊕AES(K, x′+4)

The client can then code the last 4 blocks of the message M by using these 4 new blocks Sᵢ. In practice, the client then computes:

c₅=m₅⊕S₅; C₆=M₆⊕S₆; c₇=m₇⊕S₇; C₈=m₈⊕S₈

Thus, by applying the present invention twice, the client has been able to code the message M as a coded message C defined by

C=c₁ c₂ c₃ c₄ C₅ c₆ c₇ c₈

From C, it is not possible to retrieve the value of M without knowing the secret key K shared only by the server and the client.

The client then sends (step E₄) to the server the message C and the pair (x,x′) of initial data.

On receiving the pair (x,x′), the server can, by also applying the present invention twice, recompute (step E₅) the values

S₁=AES(K, x)⊕AES(K, x+4)

S₂=AES(K, x+1)⊕AES(K, x+4)

S₃=AES(K, x+2)⊕AES(K, x+4)

S₄=AES(K, x+3) AES(K, x+4)

and

S₅=AES(K, x′)⊕AES(K, x′+4)

S₆=AES(K, x′+1)⊕AES(K, x′+4)

S₇=AES(K, x′+2)⊕AES(K, x′+4)

S₈=AES(K, x′+3)⊕AES(K, x′+4)

and then compute

c₁⊕S₁=(m₁⊕S₁)⊕S₁=m₁⊕(S₁⊕S₁)=m₁⊕0=m₁

c₂⊕S₂=(m₂⊕S₂)⊕S₂=m₂⊕(S₂⊕S₂)=m₂⊕0=m₂

c₃⊕S₃=(m₃⊕S₃)⊕S₃=m₃⊕(S₃⊕S₃)=m₃⊕0=m₃

c₄⊕S₄=(m₄⊕S₄)⊕S₄=m₄⊕(S₄⊕S₄)=m₄⊕0=m₄

c₅⊕S₅=(m₅⊕S₅)⊕S₅=m₅⊕(S₅⊕S₅)=m₅⊕0=m₅

c₆⊕S₆=(m₆⊕S₆)⊕S₆=m₆⊕(S₆⊕S₆)=m₆⊕0=m₆

c₇⊕S₇=(m₇⊕S₇)⊕S₇=m₇⊕(S₇⊕S₇)=m₇⊕0=m₇

c₈⊕S₈=(m₈⊕S₈)⊕S₈=m₈⊕(S_{8i ⊕S}₈)=m₈⊕0=m₈

The server has thus been able to recompute (step E₆) the decoded message

M=m₁ m₂ m₃ m₄ m₅ m₆ m₇ m₈ thanks to its knowledge of K. The server then knows the transfer order that it can now execute.

### Example of Use of the Method Used in an Authentication Device

Let us consider a distributor 3 of chargeable digital contents, having different clients. For a client of the distributor to be able to access a content, he must first prove to the distributor that he has the right to obtain this content.

To do this, the distributor supplies the client with a terminal 4 and a chip card 5 containing:
a read-only memory area, 5₁ containing
   a secret key K known only to the distributor (who will, for example, have fabricated the card himself) and specific to the card. For example, we will consider that it is a key of size 128 bits that can be used for AES. AES (K, t) will be used to denote the encryption of the 128-bit word t by using the secret key K.
   u*t binary coefficients (that can be identical for each card). For example u=4 and t=5. It can be assumed that these coefficients are represented in the ROM 5₁ in the form of a matrix G of size 4*5 defined by

$$G = \begin{matrix}1 & 0 & 0 & 0 & 1 \\ 0 & 1 & 0 & 0 & 1 \\ 0 & 0 & 1 & 0 & 1 \\ 0 & 0 & 0 & 1 & 1\end{matrix}$$

a hard-wired logic area or a processor 5₂ capable of performing the computations associated with the invention, in particular capable of implementing AES computations for this example.
a communication interface 5₃ to be able to exchange data.

To authenticate the client, the distributor can send the client an initial value x (step E₁₀). The chip card, on receiving x, will then implement the steps of the method according to the invention, by taking as parameter the key K and the matrix G stored in ROM and the initial value x sent via the distributor. The chip card computes (step E₁₁) the 4 blocks of 128 bits defined by

S₁=AES(K, x)⊕AES(K, x+4)

S₂=AES(K, x+1)⊕AES(K, x+4)

S₃=AES(K, x+2)⊕AES(K, x+4)

S₄=AES(K, x+3)⊕AES(K, x+4)

The chip card then returns the 4 blocks Sᵢ, (that can be considered as a single block of 512 bits), step E₁₂. On receiving these 4 blocks, the distributor also computes, according to the invention and with the parameters K, G and x, 4 blocks of 128 bits (step E₁₃). If these 4 blocks are identical to the four received, then the client is authenticated with the distributor and can logically obtain the content to which he has legitimate access (steps E₁₄ and E₁₅).

Without departing from the context of the invention, the method can also be used to authenticate the data exchanged in a system.

### BIBLIOGRAPHY

[ABAG01] 2D-Encryption Mode, A. A. Belal and M. A. Abdel-Gawad, SPIE, volume 4793, 2003, 64-75.
[BDJR97] A Concrete Security Treatment of Symmetric Encryption, M Bellare, A. Desai, E. Jokipii and P. Rogaway, FOCS 1997, 394-403.
[IWA06] New Blockcipher Modes of Operation with Beyond the Birthday Bound Security, T. Iwata, Fast Secure Encryption 2006, 331-348.
[KNU00] Block Chaining Modes of Operation, L. R. Knudsen, NIST call for new modes of operation, 2000.
[NIST01] Recommendation for Block Cipher Modes of Operation, Methodes and Techniques. M Dworkin, NIST Special Publication 800-38A, 2001.
[SLLLY01] Concrete Security Analysis of CTR-OFB and CTR-CFB Modes of Operation. J. Sung, S. Lee, J. Lim, W. Lee and O. Yi. 4th International Conference of Information Security and Cryptology 2001, 103-113.

1. A method for generating pseudo-random bit strings in a system in which the data interchanges between a first user and a second user are protected, wherein it comprises at least the following steps:
using an application f_{K} of output size n bits,
determining a value x and from this value x and by applying the application f_{K} a number of times, in order to generate t values vᵢ,
from the t values v, and the u*t coefficients, determining u blocks Sᵢ containing pseudo-random characters.

2. The method as claimed in claim 1 for generating pseudo-random bit strings, within a system comprising a module for coding data, such that a message of b=f*u*n+q bits, in which f and u are greater than or equal to 0 and q is between 0 and u*n, can be placed in the form of f groups of u blocks of n bits and an (f+1)th group of q bits, wherein:
the coding of a group concerned of n blocks comprises at least the following steps:
for the group concerned, choosing an initial value x,
from the t values v, generated and from u*t coefficients, determining u blocks Sᵢ containing pseudo-random characters in order to code the u blocks of the group concerned,
combining the u blocks of the group concerned with the u blocks Sᵢ in order to obtain the coded group,
reiterating these three steps for the f groups,
for the (f+1)th group of q bits,
choosing an initial value of x,
from the t values vᵢ generated and from u*t coefficients, determining a number of blocks Sᵢ equal to at least the top integer part of q/n,
combining q bits extracted from the Sᵢ blocks determined with the q bits of the (f+1)th group.

3. The method as claimed in claim 2, wherein the u*t coefficients are varied by varying the value of t.

4. The method as claimed in claim 1, wherein the blocks Sᵢ are obtained in the following manner:
Sᵢ=(α_{i,1} [symbol] v₁)⊕(α_{i,2} [symbol] v₂)⊕(α_{i,3} [symbol] v₃)⊕ . . . ⊕(α_{i,3} [symbol] v₂)
Where ⊕ is the multiplication with
in the case α_{i,j}=1, a_{i,j} [symbol] vⱼ=vⱼ
in the case α_{i,j}=0, a_{i,j} [symbol] v₁=0

5. The method as claimed in claim 1, wherein the blocks Sᵢ are obtained in the following manner:
Sᵢ=(α_{i,1} [symbol] v₁)⊕(α_{i,2} [symbol] v₂)⊕(α_{i,3} [symbol] v₃)⊕ . . . ⊕(α_{i,3} [symbol] vₜ)
with, for the α_{i,j} such that 0≦α_{i,j}≦1, α_{i,j} [symbol] vⱼ representing the selection of a_{i,j}% of the n bits, according to a selection criterion known to the application.

6. The method as claimed in claim 2, wherein the value of the block mᵢ of index i coded by Cᵢ=mᵢ⊕Sᵢ is determined with ⊕ corresponding either to the xor operation, which equals the bit-by-bit “exclusive or” operation, or to the modular addition modulo 2ⁿ.

7. The method as claimed in claim 1, wherein the values t can be obtained by applying a function g chosen from the following list:
gᵢ(f_{K},x)=f_{K}(x+i−1),
gᵢ(f_{K},x)=f_{K}(Lⁱ(x)) in which Lⁱ corresponds to the ith iteration of an LFSR or of a divider register,
gᵢ(f_{K},x)=f_{K}(aᵢx+bᵢ) in which aᵢ and bᵢ are coefficients of an affine transformationation,
gᵢ(f_{K},x)=f_{K}(aᵢx+bᵢ mod 2ⁿ) in which aᵢ and bᵢ are coefficients of an affine transformationation,
gᵢ(f_{K},x)=f_{K}(x+i−1)⊕dᵢ, in which ⊕ represents the bit-by-bit xor operation and dᵢ is a bit string,
gᵢ(f_{K},x)=f_{K}(x+i−1)⊕dᵢ, in which ⊕ represents the bit-by-bit xor operation and dᵢ is a bit string,
gᵢ(f_{K},x)=f_{K}(Lⁱ(x))⊕dᵢ, in which Lⁱ corresponds to the ith iteration of an LFSR or of a divider register, ⊕ represents the bit-by-bit xor operation and dᵢ is a bit string.

8. The method as claimed in one of claims 1 to 7, characterized in that the function f_{K} is a permutation.

9. The method as claimed in claim 1, wherein the u*t coefficients correspond to the coefficients of a matrix of a linear code.

10. The method as claimed in claim 1, wherein the value x is stored or generated by executing a random or pseudo-random or deterministic process.

11. The use of the method as claimed in claim 1 for the authentication of users of a system or for the authentication of data.
